(19) United States
(12) Patent Application Publication
(10) Pub. No.: US 2021/0369416 A1
(43) Pub. Date: Dec. 2, 2021

(54) ORTHODONTIC BRACKET BONDING GUIDE, INSERTION TOOL AND METHOD

(71) Applicant: Fei Gao, Buena Park, CA (US)

(72) Inventor: Fei Gao, Buena Park, CA (US)

(21) Appl. No.: 16/888,789

(22) Filed: May 31, 2020

(51) Int. Cl. A61C 7/14; A61C 7/00; A61C 7/28

(52) U.S. Cl. CPC A61C 7/146; A61C 7/282; A61C 7/145; A61C 7/002

(57) ABSTRACT

A bracket bonding guide, insertion tool and method to place orthodontic brackets to predetermined positions and orientations. Indirect bonding trays typically are made to fit specific brackets of specific shapes and parameters. Design software has to include bracket CAD files in order to work for specific brands. This invention presented a bonding guide with guiding features and insertion tools with alignment mechanism and guiding features that ensure the brackets will be placed onto right positions regardless the actual shape and dimensions of the brackets.

### CROSS-REFERENCE TO RELATED APPLICATIONS

U.S. Ser. No. 15/874,882A1, Jan. 19, 2018, Ning Dou, Fei Gao

### FIELD OF THE INVENTION

The present invention generally relates to image guided orthodontic bracket placement. Bracket bonding is a very tedious process and very difficult to control the results if done with free hand. A computer-generated bonding guide can help place brackets at the predefined positions and orientations. Indirect bonding trays have been used to reduce the time of treatment and increase the accuracy. However, treatment planning for indirect bonding trays generally have to be tied with actual bracket parameters, and the CAD/CAM of bonding trays is a relatively complex process. This invention presents a bracket bonding guide and insertion tool, which is an improved implementation of the applicant's another application U.S. Ser. No. 15/874,882A1. This invention features tools and methods independent of bracket parameters.

### BACKGROUND OF THE INVENTION

The present invention relates generally to the field of orthodontics. One objective in orthodontics is to move patient's teeth to desired positions so that the teeth function optimally and are also aesthetically pleasing. Conventional appliances such as braces and wires can be positioned on a patient's teeth by a treatment provider. Once mounted on the teeth, the hardware exerts continuous forces on the teeth and gradually moves the teeth toward their ideal positions.

Orthodontic brackets are often bonded directly to the patient's teeth. Typically, a small quantity of adhesive is placed on the base of each bracket and the bracket is then placed on a selected tooth. Before the adhesive is set, the bracket is maneuvered to a desired location on the tooth. Once the adhesive has hardened, the bracket is bonded to the tooth with sufficient strength to withstand subsequent orthodontic forces as treatment progresses.

With this technique it is very difficult to access the optimal surface for bracket placements and to assure the brackets to be placed in ideal positions. The amount of time needed to carry out the bonding procedure may be a nuisance both to the patient as well as to the treatment provider. Also, the necessity of minimizing moisture contamination from the patient's saliva can prolong the procedure and also unduly impair the accuracy of placement of the brackets on the teeth.

Indirect bonding was introduced to overcome the problems of direct bonding. Typically, an impression of each of the patient's dental arches is taken and a replica plaster or ‘stone’ model is made from each impression and sealed. Brackets are bonded to the sealed stone models using temporary cement. A transfer tray is then made by placing lab materials over both the model and the brackets on the model. For example, thermal forming materials and process are used to make a shape like retainers having bracket receiving spaces. The indirect bonding approaches normally require soft materials so that the tray can be taken out when the brackets are in position, or they require small jigs to cover an area of a small number of teeth so that the brackets can be placed properly in a relatively short time by the jigs before the target tooth areas are contaminated. An additional problem with the indirect bonding method is that brackets may become dislodged during the removal of the trays from the dental arches.

Even though digitally designed bracket bonding trays have been introduced in recent years, people no longer need to transfer from lab models to patient's mouth, the problems with the approach remains. Lab cannot simply print a 3D model holding the brackets and expect that the model can be placed on the teeth, brackets can be bonded and separated from the guide, and then the model can be taken out easily, because the undercuts of the teeth and the brackets as well as the whole arch shape can simply lock the trays on the arch together with the brackets. In practice, bracket bonding guides are typically made with soft materials, and/or as small sections covering 2-4 teeth.

U.S. Ser. No. 15/874,882A1 disclosed a new approach. The bracket bonding guide is designed to have a receiving geometry, a bracket extension component is introduced to hold brackets and inserted into the receiving geometry of the guide. With that approach, bracket bonding guides no longer have to have specific shapes to receive brackets. They need just geometric features to hold the extension structure. Bracket bonding guide design software no longer needs to deal with various parameters of brackets, but just some universal design of the extension structure.

The problem to design and make guides according to bracket geometries and parameters then becomes a task of making extension parts according to the brackets. Therefore, a treatment planning software is now independent of brackets, but the manufacturers have to provide extension components made for their brackets.

In this invention, an improved system and method are introduced. The bracket extension structure in U.S. Ser. No. 15/874,882A1 is changed to an insertion tool, the relationship between the insertion tool and the bonding guide is now implemented through guiding features. Both the bonding guide and insertion tool are now independent of the bracket parameters.

### SUMMARY OF THE INVENTION

In this disclosure, brackets should be understood as any dental appliances that are attached to teeth for orthodontic treatments. One aspect of the invention provides an orthodontic apparatus, or an insertion tool, to hold and insert a bracket into a predetermined position on a bonding guide. Another aspect of the invention provides a bonding guide having a targeted position for the insertion tool so that when the tool is at the right position, the bracket is. The image guided bracket bonding is performed by guiding insertion tools into desired positions.

For each bracket, there is a predefined insertion direction or path. Typically, the direction is the normal orientation of the tooth surface at the center of the desired bracket position. It can also be the direction that is perpendicular to the bracket slots for the arch wire and pointing from lingual side to buccal or buccal to lingual. With crowded teeth, when the space is limited or not feasible for the said orientations, one can design another path as long as the bracket as well as the insertion tool can go into the right position without colliding with other teeth or brackets.

The physical implementation of this insertion path is a guiding feature as referred in the remainder of the disclosure for each of the teeth. A guiding feature of a bonding guide is a geometric structure that can allow the insertion tool to move into the destination point from certain initial position following the insertion path. The guiding feature can be simply a hole or a slot. The hole or slot is placed somewhere on the bonding guide base body, typically above the corresponding tooth by 2-5 mm, with a cross section of for example a rectangle. A guiding pin is another embodiment for the guiding feature. It can be a rectangular extrusion feature going out from the base body and is parallel to the insertion direction. The guiding features sometimes are referred as male or female features, as the terms used in mechanical engineering.

In the meantime, the insertion tool has a guiding feature that matches the guiding feature on the bonding guide. When the guiding feature on the guide is a hole or a slot, its counterpart on the insertion tool is a pin or a protrusion feature. In general, one is a male feature, another one is a female feature. The side surfaces of the guiding features are also referred as sliding surfaces in the remainder of the disclosure, through which the insertion tool slides into the targeted position.

This insertion tool has mechanical structures or mechanisms to hold and release a bracket. An example is a plier like design, which has two arms that can hold a bracket.

The insertion tool has a mechanism to ensure whenever a bracket is held in place, its positional relationship with the insertion feature is fixed regardless of the width or the geometry of the bracket. This is necessary to ensure bracket to be positioned properly by guiding insertion tools.

Still another aspect of the invention provides an orthodontic process (e.g. a CAD/CAM process) for bonding an orthodontic bracket, comprising:

(a) providing a digital anatomy representing at least the patient's dental arch such as a tooth;

(b) providing a digital model representing an orthodontic bracket having a bonding surface configured for bonding to the patient's dental arch such as a tooth;

(c) determining the bonding surface's bonding position and orientation on the patient's dental arch such as a tooth;

(f) designing and manufacturing a customized bonding guide including a matching construction that matches, and can releasably engage with, at least a portion of the patient's dental arch such as a tooth, and at least one guiding feature providing an insertion direction and sliding surfaces.

(g) using a specially made insertion tool to hold a bracket and slide the guiding feature of said insertion tool into the guiding feature of the bonding guide.

(h) placing the bracket by sliding the positioning tool's guiding feature into the bonding guide.

### BRIEF DESCRIPTION OF THE DRAWINGS

FIG. 1 illustrates the insertion paths for bracket placement.

FIG. 2 shows a bonding guide and its major geometric features.

FIG. 3 shows a bracket bonding guide, a bracket, and an insertion tool.

FIG. 4 illustrates the design of the heads of bracket clamping arms.

FIG. 5 shows the mechanism that can maintain the relationship of the two clamping arms and their heads.

FIG. 6 shows a different embodiment of an insertion tool.

### DETAILED DESCRIPTION

In this invention, the bracket bonding is performed with a bonding guide, an insertion tool, and brackets. The insertion tool will clamp and hold a bracket, and is inserted into the bonding guide so that the bracket is at the desired position and orientation on the tooth surface.

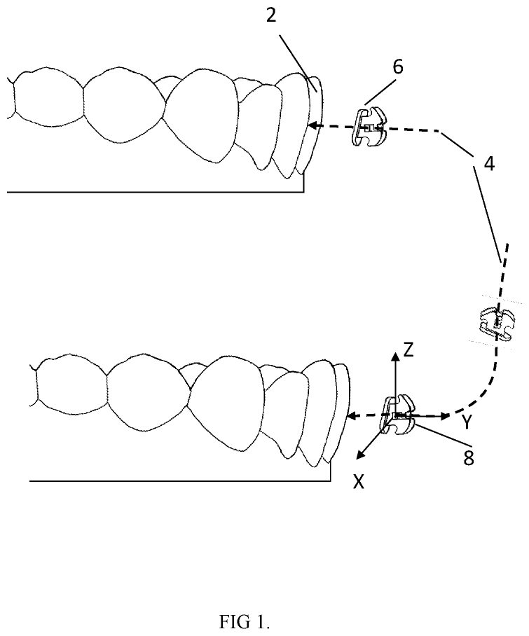

The bonding guide and the insertion tool defines an insertion path and two sets of surfaces that guide the tool into the destination. In FIG. 1, a linear insertion path and a non-linear one are illustrated. Assuming the orientation (coordinate system 8) of a bracket 6 with reference to the insertion path 4 is correct and maintained, the bracket can move along the insertion path to reach the final position on tooth 2.

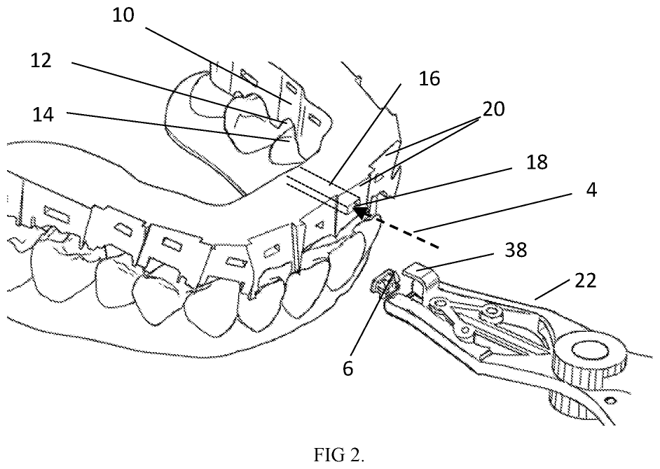

The bonding guide of this invention has three major geometric features as in FIG. 2. The base body 10 typically has a block of material with cavity areas 12 matching or substantially matching some of the tooth occlusion area 14 and maybe some buccal and lingual areas of the teeth. It can also be a shape like a retainer or a thick ortho aligner. The bonding guide can be easily and stably placed onto the patient tooth structures across a plurality of teeth or an entire arch. It can be easily released and removed from the tooth structures because all the undercuts have been blocked in the tooth fitting area.

For each bracket, there is a guiding feature 16 on the guide. The guiding feature defines an insertion path 4 and has a set of side surfaces 18, the four walls of the slot in this example. With the guiding feature, the movement trajectory of the insertion tool is constrained as predetermined. The side surfaces that will be touching and guiding the insertion tool are called sliding surfaces. For regular buccal brackets, the guiding features will guide the brackets to the buccal side of tooth surfaces; for lingual brackets, the guiding features will guide the brackets toward the lingual side.

For each guiding feature, there must be a stopper that can prevent the insertion tool from going too deep. The stopper can be a bottom face of the said guiding feature, or as in FIG. 2, a flat surface 20 at the entrance. Once the insertion tool reaches this plane, it will stop.

In an alternative embodiment, the guiding feature can be a protrusion geometry such as a rectangular boss feature going out of the stopping plane.

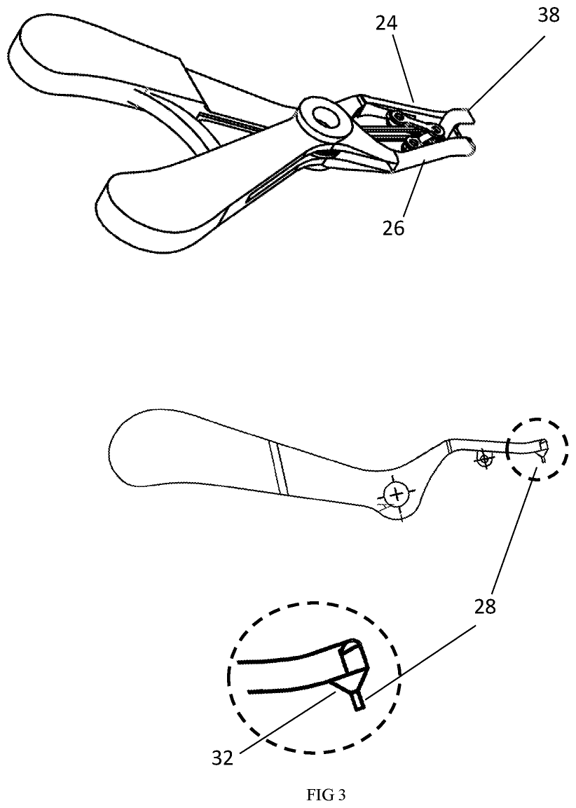

The bracket insertion tool is designed according to the bonding guide sharing the same design of the insertion path. As illustrated in FIG. 3, an embodiment of the insertion tool has a basic design of a plier. It has two arms 24, 26 that open and hold a bracket.

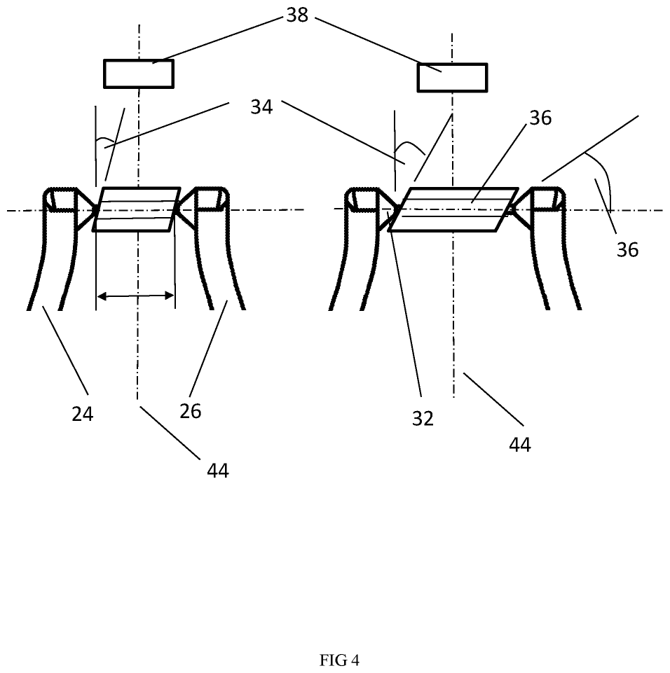

Both arms have a cylinder 28 that inserts into the bracket slot 30 and hold the bracket as in FIG. 4. Bracket slot typically has two or three standardized dimensions, and normally are rectangular. With the two cylinders holding it, the bracket can rotate about the axis. This gives some flexibility to make the bracket adapt to tooth surface when the bracket or guide have manufacturing errors, or the treatment plan is not perfect. In an actual implementation this cylinder can be also just a rectangular shape fitting into the slot.

Next to the cylinders are two cones 32 as in FIG. 3. The brackets typically will have some tipping angles as 34 shown in FIG. 4. The insertion tool is expected to hold the bracket firmly regardless of the shape, width, and angle of the bracket. In the remainder of this disclosure, the bracket parameters are used to represent collectively these aspects, or either of them.

The bracket width typically will be smaller than 10 mm, and the tipping angle is within 20 degrees range. In the remainder of this disclosure, when a bracket of any size or any width or any parameters is referred, it should be understood that those parameters are within a regular range.

Assuming the tipping angle of the bracket is 10 degrees, the cones' half angle 36 must be less than 80 degrees so it can hold the bracket and still allow the bracket to rotate about its axis. If maximum tipping angle is 20 degrees, then a half angle smaller than 70 degrees can leave enough space for the bracket to rotate. Some smaller angle like 45 degrees will be a safe choice.

With cones like this holding a bracket, the bracket can be held in a fixed position and still able to rotate about the centerline of the bracket slot. This structure is able to work for brackets of any width and tipping angles.

The second important feature of the insertion tool is the guiding feature 38 that will match and engage with the guiding feature 16 on the bonding guide through its sliding surfaces. Needless to say, the two guiding features will share the same insertion path, whether a linear or a non-linear curved one, and their surfaces will match each other so that the insertion tool can be guided into the designed position with the guiding features. The relationship between the guiding features of the bracket and the insertion tool is no different than any kind of tracks that enable the movements of two objects according to a predefined trajectory.

In the bonding guide the positional relationship between a guiding feature and its bracket has been predetermined according to the insertion tool to be used. Since the guide has been made, the insertion tool has to maintain this relationship during an actual bracket placement. With the illustration in FIG. 4, even though the bracket can have different width, the clamping arms have to work in a way such that the bracket always at a predetermined position with reference to the guiding feature 38. Only if so, the bracket will end up at the desired location when the guiding feature is in place. If the two arms cannot maintain a consistent position, the bracket cannot maintain its relative position with reference to the guiding feature. As with any pliers, there is barely any guarantee that the arms will be always symmetric to a predetermined center plane. Additional structure is introduced in this invention.

Even though there are infinite ways to maintain this relative position, a simple approach is to ensure the center plane 42 of the guiding feature on the insertion tool is always aligned with the center plane 44 between the two clamping arms no matter how much the tool will be opened and what the width and tipping angles are for a given bracket. If they are not aligned horizontally as described, their horizontal distance will need to be persistent so that the horizontal position of the bracket is fixed with respect to the guiding feature. The vertical distance between the arms and the guiding feature is predetermined and will not change when the arms are open or close, so is relatively easy to maintain.

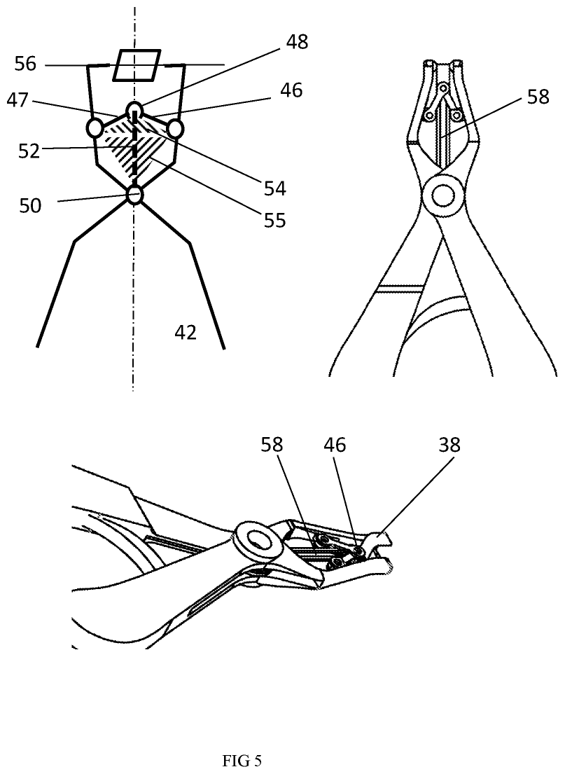

FIG. 5 illustrates an embodiment of the mechanism to maintain the relationship between two center planes. Two additional arms 46 and 47 are connected to the clamping arms. The intersection point 48 of this two arms and the intersection point 50 of the two clamping arms form a virtual centerline 52. Two triangles 54 and 55 are formed with the introduction of these two arms. No matter how this insertion tool is opened or closed, the two triangles will always ensure this centerline 52 to remain in the middle of the two arms and perpendicular to the connected lines 56 of the two clamping heads. The two clamping arms are always symmetric to this center line. A connector 58 is then used to represent the virtual center line and the guiding feature is attached at the end of the connector along the direction of this virtual line. Connector 58 has a slot so the joint point 48 can move along the center line when the arms open and close. The guiding feature 38 is then mounted onto 58, or 46, or just part of either one.

With this design, the insertion tool has now a characteristic that is not found in prior art of bracket bonding. Regardless the actual bracket width and tipping angle, the tool can hold a bracket in a desired position. Combining the bonding guide and insertion tool, the actual treatment can be performed in exactly the same protocol. Even if a bracket is exchanged with another one of different parameters, the guide and the insertion tool can still be used. This has never been possible in the prior art.

In the above description of the insertion tool, the accessibility of the bracket receiving area is not discussed. The illustrated insertion tool as in FIG. 3 can very well work with anterior area and premolar area but might have difficulty approaching the posterior area due to the limited available space between the facial tissues and the teeth. Orthodontists have many pliers and nippers that turn an angle about 90 degrees in the head area or with long arms so the head of the tool is in the posterior area, but the handles are in the anterior area. Similar modifications of the insertion tool can be proposed with same clamping arms, similar guiding feature and mechanism to control their alignment, but handle shifted to anterior area. The embodiment of the actual tool working for posterior is not elaborated in this disclosure.

Another approach is to modify the bracket extension in application U.S. Ser. No. 15/874,882A1 so that it can work for different bracket parameters and maintain the center position as the insertion tool in FIG. 4 does. This way, each bracket is attached an insertion tool, and the insertion tool is relatively small, and easy to be used in posterior area.

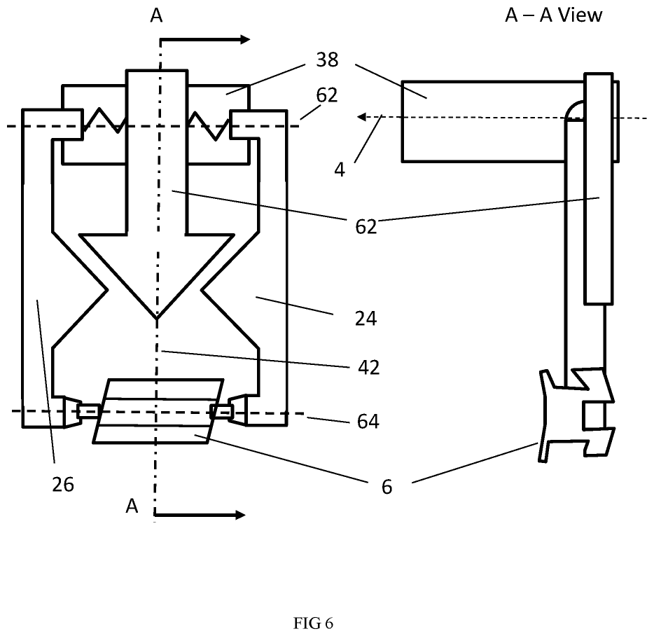

FIG. 6 illustrates an embodiment of this extension structure. The guiding feature 38 is on the top. It will be inserted into the rectangular slot on the bonding guide. Unlike in FIG. 3 where two arms 24 and 26 intersect each other, they are parallel in this embodiment. They are connected by a component such as a spring at an axis parallel to the bracket slot. They are inserted into the guiding feature and go from the guiding feature down to the bracket bonding area. The clamping heads have the same design as in FIGS. 3 and 4. The arms are opened and closed by pushing the slider 62 up and down. The slider can be implemented as any other mechanism that can open and close the clamping arms and keep them parallel. An assembly mating condition between the slider and the guiding feature is provided. A simple embodiment is that the slider is inserted into the guiding feature through a slot. This mating condition of course can be implemented with various mechanisms. The center plane 42 of the clamping arms, the slider 62 and the guiding feature 38 are always horizontally aligned so that the bracket will get right on the middle line of the guiding feature and thus align with the predetermined horizontal position of the bracket. With the clamping arms always moving symmetrically controlled by the slider, they maintain parallel so that the distance between the guiding feature axis 62 and the bracket slot 64 is fixed, thus the vertical position of the bracket can be maintained with respect to the underlying teeth.

With the bonding guide and insertion tool, a bracket bonding guide system comprises
(a) a digital treatment plan with bracket brand, key parameters such as torque, width, bracket positions on the tooth surfaces, and arch wire shape if necessary. In clinical practice, there might be various of ways to determine the positions of the brackets. For example, some place brackets in the middle of the centerlines of crowns, some would plan final tooth positions and create a virtual arch curve to determine the bracket positions. Either way the treatment plan should designate the final bracket positions.
(b) a bonding guide designed according to the treatment plan. The bonding guide will have a base body that can engage stably with the tooth surfaces and can be released from the tooth surface. It also has a set of guiding features such as holes. Each guiding feature is corresponding to one bracket. It defines an insertion direction or path, and a set of sliding surfaces that will guide an insertion tool to the desired position.
(c) a bracket insertion tool, with two clamping arms and a guiding feature. The clamping and placement of brackets are independent of the bracket geometry and size. Even better, the insertion tool has a mechanism to ensure the alignment of the clamping arms with reference to the guiding feature.
(d) Brackets and arch wires.

With the bonding system, the method to place brackets has the following major steps:

First, a software system is used to plan orthodontic treatments. Scan files of patient dental structures are loaded into the system that simulates bracket placements with virtually created bracket models. The treatment planning process can be very different depending on what planning will be carried out. Typically, all the teeth will be segmented from the scan files first. This would involve detection and/or tracking of the tooth boundaries, extraction of the crown areas, creation of virtual tooth models with or without an area simulating the roots, as well as repairing of any topological or geometry problems on the scan such as the interproximal areas that cannot be scanned by current scanning technologies. In an ideal scenario, target positions of the teeth are planned, movement paths of all the teeth are simulated before the brackets are placed and simulated.

Brackets can be initially placed onto the crown centers on the facial sides, or lingual side for lingual brackets, and then users can adjust the bracket positions manually using interaction tools. What is specially of interest is that some postprocess will be applied to bracket positions. Brackets, if not customized according to tooth geometries, cannot completely adapt to the crown surfaces. A treatment planning software may need to snap any user specified position and orientation toward an optimized position that the bracket will have an optimized contact area with corresponding tooth.

The software will generate bracket slot positions and orientations according to the treatment plan. This information is used to design the bracket bonding guide. The geometry information such as the bracket shape and width are not a concern for guide design even though they are necessary for bracket simulation, because the insertion tool in this invention will ensure the right position regardless of the bracket parameters.

After the treatment planning, the software can design bracket bonding guides comprising a plurality of guiding features according to a plurality of brackets, wherein each of the said guiding features defines an insertion path for an insertion tool. It is up to the technicians or the clinicians whether they need to have one guide covering a full arch, or they want multiple guides with each covering only a section of the arch.

Bracket bonding guides are normally fabricated by 3D printing. In a conventional process to make indirect bonding trays, brackets are placed onto dental models, and thermal forming is used to make the trays, and the brackets are carried by the tray and transferred onto patient's dental teeth. The tray material is flexible so it can be taken out of the teeth even though the teeth have undercut areas and may prevent a rigid guide to be placed or released.

Even though with the 3D printing used to directly make bonding guides or more precisely bonding trays, the bonding guides such as those from Insignia of Ormco carries over the idea to transfer brackets from the trays into the teeth, where the brackets are fixed onto the trays. It is generally impossible to make a full arch tray without flexible material or multiple materials that allow the release of the brackets from the bonding trays.

With the bracket bonding guide disclosed in this application, printing bracket bonding guides directly of rigid material for an entire arch becomes possible. This is an important aspect of this invention.

In this invention, the brackets are guided into final positions through the insertion tool and the guiding features. In actual embodiment, when insertion tools are small enough such as the one in FIG. 6, one can attach multiple insertion tools unto the bonding guide and clamp the brackets onto every or some of the insertion tools. This is referred as pre-engagement. On the contrary, the brackets can be placed onsite when the bonding guide has been placed onto the patient's teeth, using the plier like design as in FIG. 2. This is referred as post-engagement. The actual implementation of the insertion tool is a critical factor to determine if a pre-engagement is possible.

At the actual treatment, tooth surfaces will have to be treated first before brackets can be placed. This process is normally called acid etching.

Once acid etching is done, the bonding guide will be placed on the patient mouth and secured properly so that it is in the right position every time a bracket is bonded. The operators can simply place adhesives onto the engaging surface of the bracket.

If using a pre-engagement approach, the operator will need to final adjust the insertion tools so that they are in the final positions. For example, when the guide and insertion tools are assembled in a lab, the insertion tools might not have been fully pushed into the guide, so final adjustments are needed. If it is a post-engagement, the operator further aligns the guiding feature of said insertion tool with one of the guiding features on said bonding guide and slides the insertion tool into it.

When the said bracket clamped by said insertion tool reaches the targeted tooth, the operator will hold the insertion tool at the place so the adhesive can bond the bracket and the targeted tooth surface.

This bonding approach has many advantages. The bracket bonding is completely guided so that predefined treatment plans can be carried out. It facilitates a direct bonding process, while the dental professionals do not need to perform bracket transferring from a dental model to the guide through bonding trays. Because the bonding guide itself does not have any direct contact with the brackets or provide any housing to the brackets, the removal of the guide after the placement is very easy and straightforward. One does not need to make the guide with flexible materials as they do for the indirect bonding trays in prior art.

The bonding process is completely under the guidance and can be repeated if desired.

This cannot be accomplished with guides made with flexible material, because it may deform when being taken down and placed back.

Because the guide does not need housing area to place the brackets, it leaves the surrounding area of the bracket base free of guide materials or other jigs. The removal of excessive adhesives is no longer a problem with the design since the removal tool has access to the bracket base area.

The base body of the bonding guide can cover one or more teeth, up to a full arch. If desired, one can make multiple segments of guides or one guide for a full arch. It is more of a clinical choice other than a technical limitation for the clinicians to make multiple segments. There is no need to use multiple materials, soft materials, etc.

Yet another approach for making the bonding system and operation process is to design and make a bonding guide that works for both arches as long as the spatial relationships between the teeth, brackets and guide geometries allowed. The base body can cover the entire dental arch of the upper jaw and the lower jaw. Or, the base body covers at least one tooth from upper jaw and one tooth from lower jaw if not full jaws, with geometries fitting onto said teeth.

While the bonding guide covers a series of teeth, there might be a situation that only some of the teeth need brackets, or the guide is designed only for some of the brackets. For example, if the teeth are too crowded, one can use the same base body to design two guides. One for some of the teeth, another for the rest. There also could be situations that only some of the brackets are placed with the guiding features. With the present invention, the bonding guide can be designed with all of the flexibilities.

The bracket bonding method starts with digital treatment planning. Even though the software system is not listed as a component of the bonding system, it is the enabling system that makes the tools and methods possible. In a nutshell, the treatment planning software first loads scan files, identifies tooth and bracket positions, simulates the placement of the brackets, and then generates bracket bonding guides according to the scan files and bracket positions. The major components of a software system are as below.

The system has a module to load and visualize patient scans such as STL files from intra-oral scans, which nowadays have become a standard file format for digital design in dentistry.

A tooth segmentation module identifying tooth boundaries by detecting the color differences, curvatures, and any other available auxiliary information to obtain tooth geometries and metrics so that the treatment plans can be worked out properly.

A bracket placement module creates bracket models and place them according to tooth numbers and the positions of the teeth and allows the users to move bracket on the tooth surface.

A design module generates the bonding guides. A base body for the bonding guide is created first. The base body is typically created by some geometric modeling operations based on the dental model. For example, a computer program can get a piece of the surface on the dental model, offset it to make a solid body, and then remove the undercut areas. In order to remove the undercut area, one needs to define an insertion direction of the guide. The invisible areas along this direction is called undercut area. In dental CAD/CAM field, removing undercut areas is a very common practice.

Another way to create the base body is to start with a blank of geometry. A computer program first specifies an area for the guide to cover, from example from tooth number 4 to number 12, creates a base body accordingly, such as a disc, an extruded body or even a block, and then subtracts the geometry of the dental model from the base body. At the final step the undercut areas are blocked out.

When the guide covers multiple teeth, for example, 4 teeth or even 14 teeth, it is not necessary for the guide to have geometries matches all the tooth anatomy, especially when the base body is created from a disc like shape. As a matter of fact, as long as a guide can be stably placed and secured, the less tooth geometry is covered, the easier for the actual handling of the guides and brackets.

The insertion path or direction is a virtual path, and is realized through some surfaces of the guiding features on the guide and on the insertion tool. Those are referred as sliding surfaces. When an insertion path is a linear direction, the sliding surfaces created as an extrusion of a profile along the path, also known as 2.5D surfaces.

Theoretically, one can design any curve as the insertion path of a bracket, as long as the bracket will not collide with surrounding anatomy, brackets, and the guide itself. In certain situations, this may become a must.

An insertion path, if not simply defined by a direction, can be any trajectory going from outside toward to tooth surface. In FIG. 1, an illustration is given to show how a circular insertion path can be defined, and how it can be implemented. There is no specific limitation to the geometry of the insertion path as long as it is physically feasible to get the bracket into the right position.

The guiding features in a broader sense should be understood as a mechanism to ensure brackets to move from an initial position to a final position along a predefined path. The initial position can be any point on the movement path, but the final position can only be the planned bracket position.

What is claimed is:

1. An orthodontic bracket bonding guide, comprising
a. a base body covering an area of a dental arch over a plurality of teeth,
b. a cavity area that partially or substantially matches tooth anatomy so that the guide can be engaged with the tooth structure in said cavity area,
c. a plurality of guiding features, comprising a mechanism to ensure brackets to move from an initial position to a final position along a predefined insertion path.

2. the orthodontic bracket bonding guide of claim 1, wherein the base body covers the entire dental arch of the upper jaw, the lower jaw, or both.

3. the orthodontic bracket bonding guide of claim 1, wherein the brackets are lingual brackets and the guiding features are made to guide brackets unto the lingual surface of the teeth.

4. the orthodontic bracket bonding guide of claim 1, wherein the brackets are buccal brackets and the guiding features are made to guide brackets unto the buccal surface of the teeth.

5. the orthodontic bracket bonding guide of claim 1, wherein the base body covers at least one tooth from upper jaw and one tooth from lower jaw, with geometries fitting onto said teeth.

6. the orthodontic bracket bonding guide of claim 1, wherein the base body covers more than one adjacent teeth, and has bracket guiding features for some but not all of said teeth so that only brackets corresponding to some of said teeth can be placed using the guiding features.

7. the orthodontic bracket bonding guide of claim 1, wherein the guiding features are male geometric features extruding out of the base body such as pins.

8. The orthodontic bracket bonding guide of claim 1, wherein the guiding features are female geometric features intruding into the base body such as holes or slots.

9. the orthodontic bracket bonding guide of claim 1, wherein said insertion path is a linear path corresponding to the insertion direction.

10. the orthodontic bracket bonding guide of claim 1, wherein the insertion path is a non-linear curved path.

11. A bracket insertion tool according to said bonding guide of claim 1, comprising:
a. Two clamping arms that holds a bracket of any width within a regular bracket size range not more than 10 mm,
b. One guiding feature that engages with its counterpart guiding feature of said bracket bonding guide and guides the insertion tool into a predefined position with reference to said bonding guide.

12. The bracket insertion tool of claim 11, wherein
a. the vertical distance between said the clamping heads of the arms and said guiding feature is fixed,
b. said guiding feature of the insertion tool and the center plane between the two clamping arms are aligned, or persistent if not aligned such as having a fixed distance,
whereby the guiding feature will always guide the center of a bracket, into a predefined position.

13. The bracket insertion tool of claim 12, further comprising an alignment mechanism that introduces additional movement constraints to the guiding feature so that said guiding feature always aligns with the middle plane between the two clamping arms during the process of bracket movements independent of the bracket width and tipping angle.

14. The bracket insertion tool of claim 12, wherein the guiding feature is a rectangular pin and its direction matches the guiding features of said bracket bonding guides.

15. The bracket insertion tool of claim 13, wherein said alignment mechanism comprises a
a. first joint forming a first joint point,
b. two additional arms, and
c. each additional arm connecting said joint point and a clamping arm through a joint

16. The bracket insertion tool of claim 15, wherein
a. a connecting component connects said first joint point and the joint point between the two clamping arms, and
b. the guiding feature of said insertion tool is the same as said component or mounted on said connecting component or said first joint point so that said guiding feature has fixed spatial relationship with said connecting component.

17. The bracket insertion tool of claim 11-14, wherein
a. the guiding feature matches one of the guiding features of said bracket bonding guide,
b. the clamping arms are attached to the guiding feature,
c. the clamping arms are parallel,
d. a component such as a slider is provided to push the clamping arms open or close, to keep them parallel and to keep the movement symmetric,
e. an assembly mating condition is provided to keep said slider component and said guiding feature aligned,
whereby the center plane of the clamping arms, said slider and said guiding feature remain aligned so that the bracket will get right on the middle line of the guiding feature and thus align with the predetermined horizontal position of the bracket, and in the meantime the distance between the guiding feature and the clamping arms is fixed so that the vertical position of the bracket can be obtained as desired with respect to the underlying teeth.

18. An orthodontic bracket bonding system comprising:
a. at least a bracket bonding guide of claim 1-10, which has a predetermined bracket insertion path
b. at least an insertion tool of claim 11-17,
c. said bracket bonding guide has a plurality of bracket guiding features realizing the bracket insertion path,
d. said insertion tool has a guiding feature that ensures the insertion tool to get into said bonding guide along the insertion path.

19. The orthodontic bracket bonding system of claim 18, wherein a said guiding feature on the bonding guide has a set of guiding surfaces, said guiding feature on an insertion tool has a set of guiding surfaces, and the two sets of guiding surfaces can match with each other so that the insertion tool can slide into the bonding guide.

20. A bracket bonding method using said system of claims 18 and 19, wherein a bracket bonding guide and an insertion tool are provided, the positioning of brackets is carried out by guiding said insertion tools into predetermined positions.

21. The bracket bonding method of claim 20, wherein the step to guide said insertion tool into its predetermined position is carried out before said bonding guide is placed onto the patient's mouth, which is referred as pre-engagement.

22. The bracket bonding method of claim 24, wherein the step to guide said insertion tool into its predetermined position is carried out after said bonding guide is placed onto the patient's mouth, which is referred as post-engagement.

23. The bracket bonding method according of claim 24, further comprising the following steps.
a. providing a digital anatomy representing at least the patient's dental arch such as a tooth;
b. providing a digital model representing an orthodontic bracket having a bonding surface configured for bonding to the patient's dental arch such as a tooth;
c. determining the bonding surface's bonding position and orientation on the patient's dental arch;
d. designing and manufacturing a customized bonding guide including a cavity area that matches, and can releasably engage with, at least a portion of the patient's dental arch such as a tooth, and at least one guiding feature providing an insertion direction and sliding surfaces.
e. using a specially made insertion tool to hold a bracket and slide the guiding feature of said insertion tool into the guiding feature of the bonding guide.
f. placing the bracket by sliding the positioning tool's guiding feature into the bonding guide.
